(19) United States
(12) Patent Application Publication
(10) Pub. No.: US 2022/0134667 A1
(43) Pub. Date: May 5, 2022

(54) BUILD MATERIAL CLEANING

(71) Applicant: Hewlett-Packard Development Company, L.P., Spring, TX (US)

(72) Inventors: Rhys Mansell, Sant Cugat del Valles (ES); Mohammad Jowkar, Sant Cugat del Valles (ES); Emiliano Tolosa Gonzalez, Sant Cugat del Valles (ES)

(73) Assignee: Hewlett-Packard Development Company, L.P., Spring, TX (US)

(21) Appl. No.: 17/416,383

(22) PCT Filed: Jul. 15, 2019
(86) PCT No.: PCT/US2019/041775

§ 371 Date: Jun. 18, 2021

(51) Int. Cl. B29C 64/35; B22F 10/68; B28B 1/00; B33Y 30/00; B33Y 40/20

(52) U.S. Cl. CPC B29C 64/35; B22F 10/68; B33Y 40/20; B33Y 30/00; B28B 1/001

(57) ABSTRACT

An example of a self-cleaning apparatus for a 3D system is disclosed. The apparatus comprises a surface on which build material accumulates during a 3D printing operation. The surface has a profile that slopes generally down towards a collection point. The apparatus also comprises the collection point located in the surface to drain build material from the surface. The apparatus further comprises a vibrating source to cause the surface to vibrate. The apparatus also comprises a controller to control the vibrating source to vibrate, upon determining that a cleaning operation is to be performed, to drive build material accumulated on the surface towards the collection point.

### BACKGROUND

Some additive manufacturing or three-dimensional printing systems selectively solidify portions of successive layers of a powdered build material. In some examples, selective solidification may be achieved by selectively applying an energy absorbing fusing agent over each formed layer of build material and applying a fusing energy to the build material layer to cause portions thereof on which fusing agent was printed to heat up sufficiently to melt, coalesce, sinter, or otherwise fuse, and then to solidify upon cooling. Other examples directly apply energy in a point-to-point manner to portions of each layers to be solidified, for example using a laser.

### BRIEF DESCRIPTION OF THE DRAWINGS

The present application may be more fully appreciated in connection with the following detailed description of non-limiting examples taken in conjunction with the accompanying drawings, in which like reference characters refer to like parts throughout and in which:

FIG. 1 is a schematic diagram showing an example of a self-cleaning apparatus to clean build material accumulated on a surface.

FIG. 2 is a flow diagram illustrating an example method to clean build material accumulated on a surface.

FIG. 3A is a schematic diagram showing another example of a self-cleaning apparatus to clean build material accumulated on a surface.

FIG. 3B is a schematic diagram showing another example of a self-cleaning apparatus to clean build material accumulated on a surface.

FIG. 4 is a schematic diagram showing another example of a self-cleaning apparatus to clean build material accumulated on a surface.

FIG. 5 is a schematic diagram showing an example of a 3D printer to clean build material accumulated on a surface.

FIG. 6 is a schematic diagram showing another example of a 3D printer to clean build material accumulated on a surface.

### DETAILED DESCRIPTION

The following description is directed to various examples of additive manufacturing, or three-dimensional printing, apparatus and processes to generate high quality 3D objects. While a limited number of examples have been disclosed, those skilled in the art may appreciate numerous modifications and variations therefrom. It is intended that the appended claims cover such modifications and variations as fall within the scope of the claims. Throughout the present disclosure, the terms “a” and “an” are intended to denote at least one of a particular element. In addition, as used herein, the term “includes” means includes but not limited to, the term “including” means including but not limited to. The term “based on” means based at least in part on.

For simplicity, it is to be understood that in the present disclosure, elements with the same reference numerals in different figures may be structurally the same and may perform the same functionality.

Some examples of additive manufacturing use build material to generate 3D objects from a virtual 3D object model of the 3D object to be generated. In an example, the 3D object model may be stored in a Computer Aid Design (CAD) file. The 3D object model may, in another example, be sliced into a plurality of 2D slices corresponding to virtual cross sections of the object to be generated. Each slice may correspond to a physical build material layer.

Suitable powder-based build materials for use in examples herein may include, where appropriate, at least one of polymers, metal powder, ceramics powder such as for example, polyamides (e.g., PA11, PA12), Thermoplastic Polyurethane (TPU), and stainless-steel. Some additive manufacturing systems use build material in, for example, a powdered or granular form.

Different powders may have different characteristics, such as different average particle sizes, different minimum and maximum particle sizes, different coefficients of friction, different angles of repose, and the like. In some examples non-powdered build materials may be used such as gels, pastes, and slurries.

Some 3D printing systems comprise a 3D printer. As mentioned above, a 3D object model may be built by processing individually each of a plurality of build material layers. During the generation of the aforementioned plurality of build material layers by, for example, a recoating mechanism (e.g., roller, wiper), some build material particles may become airborne and may disperse to other parts of the 3D printer and accumulate thereon.

Other 3D printing systems may additionally comprise a build material processing station (referred hereinafter as “processing station”) in which build material is managed with respect to a build unit. The processing station may perform build material management operations such as filling the build unit with build material, separating non-solidified build material from 3D objects generated in the build unit by a 3D printer, mixing fresh build material with recycled build material, and the like. The processing station may perform these build material management operations by controlling pumps, fans, and valves that generate airflows in conduits therein that are to bring the build material particles from an end to another end. These airflows may generate airborne build material which also accumulates on some surfaces of the processing station.

The accumulation of build material on surfaces may disturb the normal operation and reliability of elements of the printing system, for example, motors, printheads, seals, recoating mechanisms, and the like.

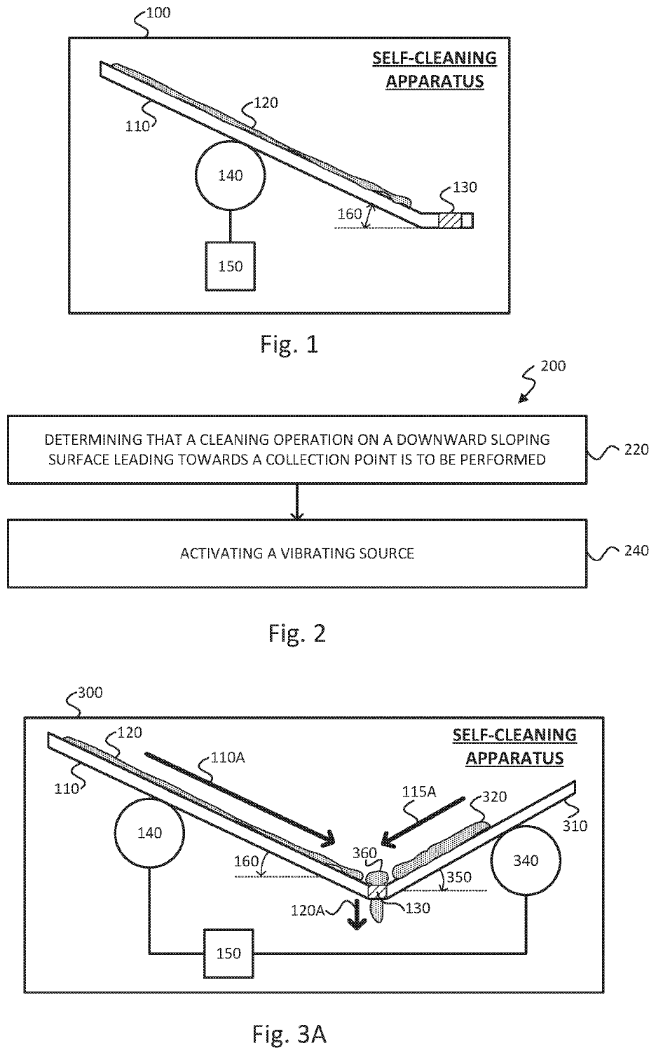

Referring now to the drawings, FIG. 1 shows a schematic diagram showing an example of a self-cleaning apparatus 100 to clean build material accumulated on a surface. The self-cleaning apparatus 100 may be suitable for an element of a 3D printing system, such as a 3D printer or a powder processing station.

The self-cleaning apparatus 100 comprises a surface 110, or plate, on which build material 120 may accumulate during processing operation. Some examples of processing operations may include the generation (e.g., spreading) of a build material layer by a recoating mechanism, lowering of a build platform (not shown) to generate a subsequent build material layer, applying airflows, such as cooling airflows, on the uppermost build material layer, and the like.

The surface 110 has a profile that slopes generally down towards a collection point 130. The slope of the surface 110 may be defined by the slope angle 160, which is an angle with respect to the horizontal plane. In an example, the slope angle 160 may range from about 1° to about 20°, for example 2°. In another example, the slope angle 160 may range from about 0.5° to about 25°, for example, 3°. In yet another example, the slope angle 160 may range from about 1° to about 50°, for example, 10°.

As mentioned above, in an example, the surface 110 may have a profile that slopes generally down. In an example, the full profile of the surface 110 slopes down. In another example, at least one segment from the profile of the surface 110 does not slope down (e.g., has a horizontal profile), and at least another segment from the profile of the surface 110 slopes down.

The collection point 130 may be an aperture located in the surface 110 to drain build material 120 from the surface 110. In an example, the collection point 130 may be an aperture, that spans a shorter distance than the full width of the surface 110. In another example, the collection point 130 may be an aperture, that spans a distance corresponding to the full width of the surface 110.

The collection point 130 may be placed at any location from the surface 110. In an example, the collection point 130 is located at about the lowest part, with respect to a vertical axis, of the surface 110. In another example, the collection point 130 is located at about the middle part, with respect to a vertical axis, of the surface 110. In yet another example, the collection point 130 is located between the highest part of the surface 110 and about the middle part of the surface 110.

The self-cleaning apparatus 100 also comprises a vibrating source 140 to cause the surface 110 to vibrate. The vibrating source 140 may be any device suitable to transfer a vibration to the surface 110, for example, a rotating machine, an impact machine, a device comprising gears, an apparatus performing acoustic excitation, a self-excited vibration system, an apparatus to perform vortex shedding, or the like. The vibrating source 140 is coupled to a controller 150.

The controller 150 may, for example, be any combination of hardware and programming to control the vibrating source 140 to vibrate. The vibration controlled by the controller 150 is intended to drive build material 120 accumulated on the surface 110 towards the collection point 130. In some examples, the controller 150 is to implement the functionalities resulting from the execution of the method 200 of FIG. 2. In some examples herein, such combinations of hardware and programming may be implemented in a number of different ways. For example, the programming of modules may be processor-executable instructions stored on at least one non-transitory machine-readable storage medium and the hardware for modules may include at least one processor to execute those instructions. In some examples described herein, multiple modules may be collectively implemented by a combination of hardware and programming, as described above. In other examples, the functionalities of the controller 150 may be, at least partially, implemented in the form of electronic circuitry.

FIG. 2 is a flow diagram illustrating an example method 200 to drive build material 120 accumulated on the surface 110 towards the collection point 130. Method 200 is described below as being executed or performed by a controller, such as the controller 150 of FIG. 1. Method 200 may be implemented in the form of executable instructions stored on a machine-readable storage medium and executed by a single processor or a plurality of processors, and/or in the form of any electronic circuitry, for example digital and/or analog ASIC. In some implementations of the present disclosure, method 200 may include more or less elements than are shown in FIG. 2. In some implementations, some of the elements of method 200 may, at certain times, be performed in parallel and/or may repeat.

Method 200 may be performed by controller 150 to control some of the elements of system 100. System 100 may initially comprise build material 120 accumulated on the surface 110. The surface 110 slopes down towards a collection point 130 to drain build material 120 from the surface 110.

At block 220, the controller 150 determines that a cleaning operation is to be performed on the downward sloping surface 110 from a 3D printing system (e.g., 3D printer, processing station) leading towards the collection point 130 to drain build material from the surface 110. In an example, the determination in which the cleaning operation is to be performed is based on a time based determination such as after a preset amount of 3D system working hours (e.g., after 10 working hours).

In another example, the determination in which the cleaning operation is to be performed is based on a periodic based determination such as at the beginning/completion of a print job.

In yet another example, the determination in which the cleaning operation is to be performed is based on a sensor determination. In an example herein, the self-cleaning system 100 may further comprise an optical sensor to measure whether the build material 120 accumulated on the surface 110 meets a preset height from a surface 110 level. The preset height is indicative of the highest amount of build material 120 that can be acceptably accumulated on the surface 110. In an example, the preset height is selected from the range defined by about 0.01 mm and about 2.5 cm, for example 0.5 mm. The controller 150 may determine that a cleaning operation is to be performed if the build material amount meets the preset height of the optical sensor. In other examples, a camera and image processor may be used to determine when a surface has accumulated more than an acceptable quantity of build material thereon.

At block 240, the controller 150 activates a vibrating source 140 to cause the surface 110 to vibrate so that an amount of build material 120 accumulated on the surface 110 is driven downwards through the slope to the collection point 130. The vibration of the surface 110 causes the build material thereon to fluidize and break potential build material agglomeration structures, thereby causing the build material 120 to slide downwards the surface 110 slope. The vibration may also fluidize build material against the friction generated between the build material and the surface 110.

In an example, the controller 150 activates the vibrating source 140 to vibrate for a preset amount of time. In other examples, the controller 150 activates and/or stops the vibrating source 140 based on a closed-loop feedback generated by, for example, a level sensor (not shown) that is to trigger a first signal to the controller when the height of the accumulated build material exceeds a first predetermined threshold and/or to trigger a second signal to the controller when the height of the accumulated build is below a second predetermined threshold.

In an example, the controller 150 controls the vibrating source 140 to cause the surface 110 to vibrate at about the natural frequency of the surface 110. In another example, the controller 150 controls the vibrating source 140 to cause the surface 110 to vibrate at a frequency other than the natural frequency of the surface 110. In the examples herein, the term “natural frequency” should be interpreted as the frequency in which a system tends to oscillate in the absence of any driving or damping force.

In another example, the controller 150 controls the vibrating source 140 to cause the surface 110 to vibrate at a frequency in the range of about 20 Hz to about 10000 Hz, for example 50 Hz. In another example, the controller 150 controls the vibrating source 140 to cause the surface 110 to vibrate at a frequency in the range of about 100 Hz to about 1000 Hz, for example 500 Hz. In yet another example the controller 150 controls the vibrating source 140 to cause the surface 110 to vibrate through a plurality of frequencies so that an amount of build material 120 accumulated on the surface 110 is driven down the slope to the collection point 130. An appropriate frequency may be determined based on, for example, the type of build material 120 used, the material of the surface 110, and/or the thickness of the surface 110.

Based on the material of the surface 110, the surface 110 vibration caused by the vibrating source 140 may cause the surface 110 to vibrate at an amplitude. The larger the amplitude in which the surface 110 vibrates, the better the build material accumulated thereon would flow towards the collection point 130. In an example, the amplitude may range from about 0.05 mm to about 7.5 mm, for example 0.1 mm or 5 mm. In some examples, however, a too large amplitude may result in creating airborne build material and thereby reduce the cleaning throughput of the self-cleaning apparatus.

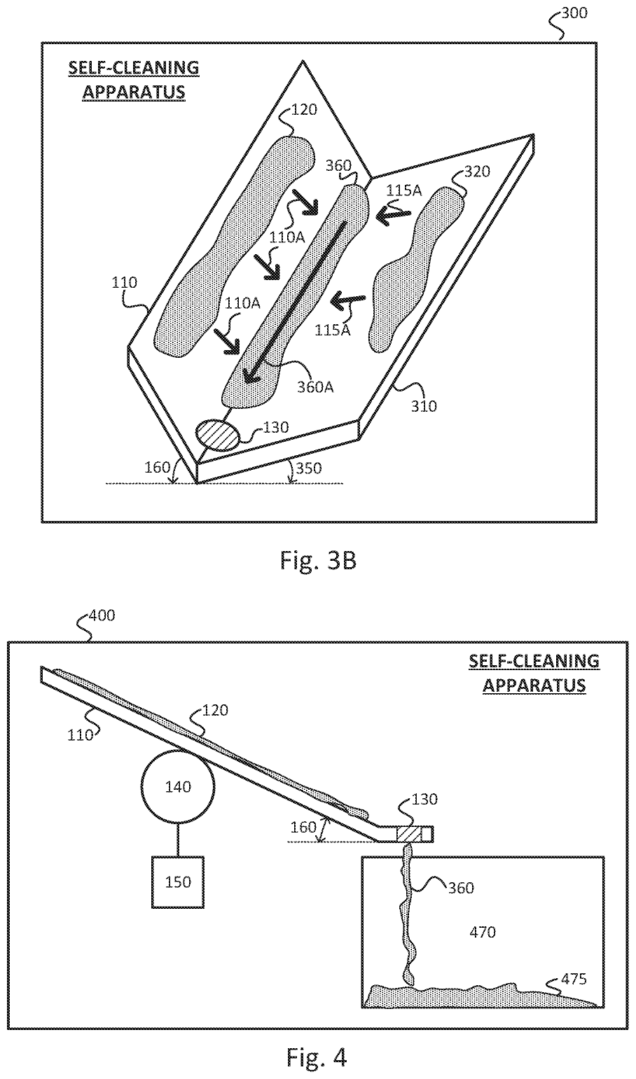

FIGS. 3A and 3B are schematic diagrams showing another example of a self-cleaning apparatus 300 to clean build material accumulated on a surface. FIG. 3A illustrates a side view from the self-cleaning apparatus 300 so that the sloped profile is appreciated. FIG. 3B illustrates a view from the self-cleaning apparatus 300 so that elements on top of the surfaces are appreciated. For illustrative purposes, some elements from FIG. 3A have been omitted in FIG. 3B and vice-versa, however, it is to be understood that FIGS. 3A and 3B intend to cover a single system 300 and the elements described in FIGS. 3A and 3B are intended to be present in the implementation of the self-cleaning apparatus 300.

The self-cleaning apparatus 300 comprises a first surface 110 with a slope profile defined by a first angle 160 and a second surface 310 with a slope profile defined by a second angle 350. The second surface 310 may have the same functionality as the surface 110 from FIG. 1. In an example, the first angle 160 and the second angle 350 are opposite angles. In another example, the first angle 160 and the second angle 350 are not opposite angles. In the examples herein, a pair of opposite angles should be interpreted to comprise opposite phase angles, for example, +2° and −2°. The first surface 110 and the second surface 310 intersect with each other at an intersection. For clarity reasons, two surfaces have been illustrated, however it is to be understood that the self-cleaning apparatus 300 may comprise a plurality of surfaces, at least two of these to intersect with each other at an intersection. In an example, each of the plurality of surfaces have about the same slope profile. In another example, at least two of the plurality of surfaces may have different slope profiles.

In an example, the self-cleaning apparatus 300 comprises a plurality of surfaces designed in an L-shape surrounding the build unit. An L-shape directing towards a collection point 130 enables build material accumulated thereon to be transferred from different corners of the build unit to a single collection point 130. In another example, the self-cleaning apparatus 300 comprises a plurality of surfaces designed in a rectangular or squared-shape substantially fully surrounding the build unit. A plurality of surfaces designed in a rectangular or squared-shape directing towards a collection point 130 enables build material accumulated thereon to be transferred from any corner of the build unit to a single collection point 130.

In the illustrated example, a first amount of build material 120 is shown accumulated on the first surface 110, and a second amount of build material 320 is shown accumulated on the second surface 310. The self-cleaning apparatus 300 further comprises at least one vibrating source to cause the surfaces to vibrate. In the example herein, the self-cleaning apparatus 300 may comprise a first vibrating source 140 coupled to the controller 150 to cause the first surface 110 to vibrate, and a second vibrating source 340 coupled to the controller 150 to cause the second surface 110 to vibrate. The second vibrating source 340 may be the same as or similar to the first vibrating source 140. In an example, the controller 150 is to cause the first vibrating source 140 and the second vibrating source 340 to cause the first surface 110 and second surface 310 to vibrate at the same frequency. In another example, the controller 150 is to cause the first vibrating source 140 and the second vibrating source 340 to cause the first surface 110 and second surface 310 to vibrate at different frequencies.

In the example herein, the controller 150 may control the first vibrating source 140 to cause the first surface 110 to vibrate and cause at least part of the first build material 120 accumulated on the first surface 110 to flow down the first surface 110 towards the intersection between the first surface 110 and the second surface 310. This flow is illustrated with arrow 110A. The controller 150 may control the second vibrating source 340 to cause the second surface 310 to vibrate and cause at least part of the second build material 320 accumulated on the second surface 310 to flow down the second surface 310 towards the intersection between the first surface 110 and the second surface 310. This flow is illustrated with arrow 115A. The flows 110A and 115A may merge at the intersection as a merged flow 360A.

As the first vibrating source 140 and/or the second vibrating source 340 vibrate, build material 360 from the merged flow 360A is driven to the collection point 130. The build material that reaches the collection point 130 flows through the collection point 130 aperture. This flow is indicated with arrow 120A.

In the examples herein, reference has been made to a first surface 110 and second surface 310. However, it is to be understood that the first surface 110 and second surface 310 may be integral subset elements from a larger surface, thereby being the first surface 110 a first subset surface, and the second surface 310 a second subset surface. In these examples, the larger surface may be 3D printed or formed from a single sheet. In other examples, the first surface 110 and the second surface 310 may be separate elements that are merged (e.g., welded) together to generate the intersection.

FIG. 4 is a schematic diagram showing another example of a self-cleaning apparatus 400 to clean build material accumulated on a surface 110.

As mentioned above, the controller 150 is to control the vibrating source 140 to vibrate and thereby drive build material 120 accumulated on the surface 110 towards the collection point 130. The build material that reaches the collection point 130 flows through the collection point 130 aperture. The build material that flows through the aperture is referred hereinafter as collected build material 360.

The self-cleaning apparatus 400 further comprises a reservoir 470. The collection point 130 is to direct the collected build material 360 towards the reservoir 470 to be stored therein. The stored build material in the reservoir 470 is referred herein as build material 475. In an example, the reservoir 470 is a removable build material container to store build material 475. In another example, the reservoir 470 is an integral build material container to store build material 475.

In some examples, the build material 475 from the reservoir 470 is recycled and used in subsequent print jobs. In other examples, the build material 475 is discarded.

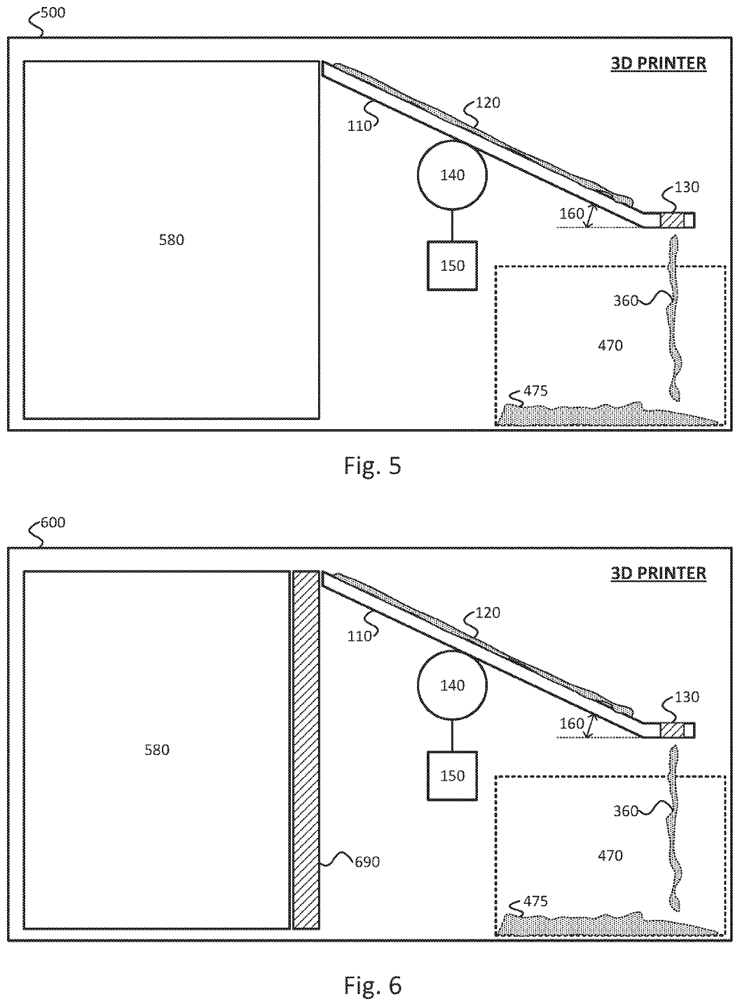

FIG. 5 is a schematic diagram showing an example of a 3D printer 500 to clean build material accumulated on a surface.

The 3D printer 500 comprises a build enclosure 580 to receive a build chamber. In some examples, the build chamber is a built-in part of the 3D printer 500. In other examples, the build chamber is in a removable build unit that is attachable and detachable from the build enclosure 580. The 3D printer 500 may also comprise a printing module (not shown) that is to generate the 3D objects in the build chamber through selective solidification.

In an example, the printing module performs the selective solidification by selectively applying an energy absorbing fusing agent over each formed layer of build material. In another example, the printing module may apply other printing fluids, such as, UV binders or thermal binding agents. In yet another example, the printing module performs the selective solidification by selectively applying a point-to-point focused energy beam (e.g., laser) or an array of point-to-point focused energy beams over each formed layer of build material.

During the printing operation, some elements from the 3D printer 500 may cause build material 120 to become airborne and subsequently accumulate on the surface 110. In the examples herein, the surface 110 is not part of the build chamber nor any element from the build chamber (e.g., build platform). In other examples, however, the surface 110 may be part of the build chamber. Upon determining that a cleaning operation is to be performed, the controller 150 is to control the vibrating source 140 to vibrate and drive build material 120 accumulated on the surface 110 towards the collection point 130. The build material that reaches the collection point 130 flows through the collection point 130 aperture (i.e., is drained) towards the reservoir 470 and may be stored therein. The build material 475 from the reservoir 470 may be recycled in a subsequent print job or may be discarded.

Performing the self-cleaning operation when a build operation is being performed by the 3D printer 500 may cause defects in generated objects. These part quality defects may be caused by the vibrations from the vibrating source 140.

FIG. 6 is a schematic diagram showing another example of a 3D printer 600 to clean build material accumulated on a surface 110. 3D printer 600 may be similar and may have a similar functionality as 3D printer 500 from FIG. 5.

In some examples, the above-mentioned self-cleaning operations are executed when no build operation is being performed by the 3D printer 600. This may cause a down-time of the 3D printer 600 and thereby reduce the 3D printer 600 throughput. In some examples however, the controller 150 controls the vibrating source 140 to vibrate during a build operation, thereby executing the self-cleaning operation when a build operation is being performed by the 3D printer 600.

In the examples herein, a build operation may comprise any suitable operation that the 3D printer 600 performs in the build chamber to generate a 3D object, for example, generating a layer of build material, selectively solidifying a portion of the uppermost layer of build material, moving a build platform within the build chamber, and the like.

The 3D printer 600 comprises a vibration insulation element 690 between the surface 110 and the build enclosure 580. The vibration insulation element 690 may be any suitable material that reduces or inhibits the transfer of the vibrations generated by the vibrating source 140. Examples of the vibration insulation element 690 may comprise an object formed by trapping pockets of gas in a liquid or solid (e.g., foam-like element).

The vibration insulation element 690 may enable the 3D printer 600 to execute a self-cleaning operation while performing 3D printing operations without compromising the part quality of the generated 3D printed parts.

The above examples may be implemented by hardware, or software in combination with hardware. For example, the various methods, processes and functional modules described herein may be implemented by a physical processor (the term processor is to be implemented broadly to include CPU, SoC, processing module, ASIC, logic module, or programmable gate array, etc.). The processes, methods and functional modules may all be performed by a single processor or split between several processors; reference in this disclosure or the claims to a “processor” should thus be interpreted to mean “at least one processor”. The processes, method and functional modules are implemented as machine-readable instructions executable by at least one processor, hardware logic circuitry of the at least one processors, or a combination thereof.

As used herein, the terms “about” and “substantially” are used to provide flexibility to a numerical range endpoint by providing that a given value may be, for example, an additional 20% more or an additional 20% less than the endpoints of the range. The degree of flexibility of this term can be dictated by the particular variable and would be within the knowledge of those skilled in the art to determine based on experience and the associated description herein.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

There have been described example implementations with the following sets of features:

Feature set 1: A self-cleaning apparatus for a 3D printing system comprising:
a surface on which build material accumulates during a 3D printing operation, the surface having a profile that slopes generally down towards a collection point;
the collection point located in the surface to drain build material from the surface;
a vibrating source to cause the surface to vibrate; and
a controller to control the vibrating source to vibrate, upon determining that a cleaning operation is to be performed, to drive build material accumulated on the surface towards the collection point.

Feature set 2: An apparatus with feature set 1, wherein the controller controls the vibrating source to cause the surface to vibrate at about the natural frequency of the surface.

Feature set 3: An apparatus with any preceding feature set 1 or 2, wherein the controller controls the vibrating source to cause the surface to vibrate at a frequency in the range of about 20 Hz to about 10000 Hz.

Feature set 4: An apparatus with any preceding feature set 1 to 3, wherein the controller controls the vibrating source to cause the surface to vibrate through a plurality of frequencies.

Feature set 5: An apparatus with any preceding feature set 1 to 4, wherein the controller controls the vibrating source to cause the surface to vibrate at a frequency other than the natural frequency of the surface.

Feature set 6: An apparatus with any preceding feature set 1 to 5, wherein the collection point is located at about the lowest part of the surface.

Feature set 7: An apparatus with any preceding feature set 1 to 6, wherein the slope of the surface is defined by an angle with respect to a horizontal plane, the angle ranging from about 1° to about 20°.

Feature set 8: An apparatus with any preceding feature set 1 to 7, further comprising a plurality of surfaces having slope profiles, wherein at least two surfaces intersect with each other, and wherein the amount of build material on the plurality of surfaces is driven to the collection point through the two surfaces intersection.

Feature set 9: An apparatus with any preceding feature set 1 to 8, wherein the collection point is to direct the collected build material towards a container.

Feature set 10: An apparatus with any preceding feature set 1 to 9, wherein the determination on which the cleaning operation is to be performed is based on at least one of a time based determination, a periodic based determination, or an optical sensor determination.

Feature set 11: A 3D printer comprising:
a build enclosure to receive a build chamber;
   a plate on which build material accumulates during a 3D printing operation, the plate having a profile that slopes generally down towards a collection point;
the collection point located in the plate to drain build material from the plate;
a vibrating source to cause the plate to vibrate; and
   a controller to control the vibrating source, upon determining that a cleaning operation is to be performed, to drive build material accumulated on the surface towards the collection point.

Feature set 12: A 3D printer with preceding feature set 11, wherein the controller controls the vibrating source to cause the plate to vibrate at about the natural frequency of the plate.

Feature set 13: A 3D printer with any preceding feature set 11 to 12, further comprising a vibration insulation element between the surface and the build enclosure.

Feature set 14: A 3D printer with any preceding feature set 11 to 13, wherein the controller controls the vibrating source to vibrate during a build operation.

Feature set 15: A method comprising:
determining that a cleaning operation is to be performed on a downward sloping surface leading towards a collection point to drain build material from the surface; and
activating a vibrating source to cause the surface to vibrate so that any build material accumulated thereon is driven down the slope to the collection point.

What it is claimed is:

1. A self-cleaning apparatus for a 3D printing system comprising:
a surface on which build material accumulates during a 3D printing operation, the surface having a profile that slopes generally down towards a collection point;
the collection point located in the surface to drain build material from the surface;
a vibrating source to cause the surface to vibrate; and
a controller to control the vibrating source to vibrate, upon determining that a cleaning operation is to be performed, to drive build material accumulated on the surface towards the collection point.

2. The apparatus of claim 1, wherein the controller controls the vibrating source to cause the surface to vibrate at about the natural frequency of the surface.

3. The apparatus of claim 1, wherein the controller controls the vibrating source to cause the surface to vibrate at a frequency in the range of about 20 Hz to about 10000 Hz.

4. The apparatus of claim 1, wherein the controller controls the vibrating source to cause the surface to vibrate through a plurality of frequencies.

5. The apparatus of claim 1, wherein the controller controls the vibrating source to cause the surface to vibrate at a frequency other than the natural frequency of the surface.

6. The apparatus of claim 1, wherein the collection point is located at about the lowest part of the surface.

7. The apparatus of claim 1, wherein the slope of the surface is defined by an angle with respect to a horizontal plane, the angle ranging from about 1° to about 20°.

8. The apparatus of claim 1, further comprising a plurality of surfaces having slope profiles, wherein at least two surfaces intersect with each other, and wherein the amount of build material on the plurality of surfaces is driven to the collection point through the two surfaces intersection.

9. The apparatus of claim 1, wherein the collection point is to direct the collected build material towards a container.

10. The apparatus of claim 1, wherein the determination on which the cleaning operation is to be performed is based on at least one of a time-based determination, a periodic based determination, or an optical sensor determination.

11. A 3D printer comprising:
a build enclosure to receive a build chamber;
a plate on which build material accumulates during a 3D printing operation, the plate having a profile that slopes generally down towards a collection point;
the collection point located in the plate to drain build material from the plate;
a vibrating source to cause the plate to vibrate; and
a controller to control the vibrating source, upon determining that a cleaning operation is to be performed, to drive build material accumulated on the surface towards the collection point.

12. The 3D printer of claim 11, wherein the controller controls the vibrating source to cause the plate to vibrate at about the natural frequency of the plate.

13. The 3D printer of claim 11, further comprising a vibration insulation element between the surface and the build enclosure.

14. The 3D printer of claim 13, wherein the controller controls the vibrating source to vibrate during a build operation.

15. A method comprising:
determining that a cleaning operation is to be performed on a downward sloping surface leading towards a collection point to drain build material from the surface; and
activating a vibrating source to cause the surface to vibrate so that any build material accumulated thereon is driven down the slope to the collection point.
